(19) United States
(12) Patent Application Publication
(10) Pub. No.: US 2017/0086257 A1
(43) Pub. Date: Mar. 23, 2017

(54) HEATING DEVICE FOR HEATING WATER AND METHOD FOR OPERATING A HEATING DEVICE OF THIS KIND

(71) Applicant: E.G.O. Elektro-Geraetebau GmbH, Oberderdingen (DE)

(72) Inventors: Roland Muehlnikel, Bretten (DE); Volker Block, Bretten (DE); Holger Koebrich, Kraichtal-Gochsheim (DE); Manuel Schmieder, Oberderdingen (DE); Bernd Robin, Kraichtal (DE); Matthias Mandl, Bretten (DE); Alfred Suss, Bretten (DE); Michael Tafferner, Malsch (DE); Sebastian Eigl, Bretten (DE)

(21) Appl. No.: 15/268,926

(22) Filed: Sep. 19, 2016

(30) Foreign Application Priority Data
Sep. 21, 2015 (DE) 10 2015 218 120.0
Sep. 21, 2015 (DE) 10 2015 218 121.9

(51) Int. Cl. H05B 1/02; F24H 1/00

(52) U.S. Cl. CPC H05B 1/0244; F24H 1/0018; H05B 2203/021

(57) ABSTRACT

A heating device for heating water has a carrier to which at least one heating element is applied, the heating element having one or more heating conductors which are connected one behind the other. The heating device has a flat dielectric layer which substantially covers the heating conductors or the heating element. An electrically conductive connection area is in each case provided on both sides of the dielectric layer with the same coverage. At least one of the connection areas is connected to a controller for evaluating a leakage current as current flows through the dielectric layer, and the heating element is connected to measuring means for monitoring a heating conductor current through the heating element. Both the leakage current and the heating conductor current are monitored over time and faults can be identified if there are conspicuous changes.

### CROSS-REFERENCE TO RELATED APPLICATIONS

This application claims priority to German Application No. 10 2015 218 120.0 and German Application No. 10 2015 218 121.9, both of which were filed Sep. 21, 2015, the contents of both of which are hereby incorporated herein in their entireties by reference.

### TECHNOLOGICAL FIELD

The invention relates to a heating device for heating water and also to a method for operating a heating device of this kind for heating water.

### BACKGROUND

US 2014/029928 A1 discloses that, in heating devices for heating water, in particular comprising a metal carrier and a heating element which is arranged on the metal carrier using thick-film technology, rapid regulation is required on account of the high area outputs and the very dynamic processes since there is low thermal inertia. Particularly in the case of local areas of limescale formation on or limescale formation over a large surface area of a medium side of the carrier, heat absorption by the water to be heated drops sharply, as a result of which primarily local heating or else heating over a large surface area can occur very quickly, and this would be very harmful. Under certain circumstances, this may even lead to the heating device being destroyed.

DE 102013200277 A1 discloses a heating device in which monitoring of the heating device or of a heating element over a large surface area and identification also of locally limited overheating phenomena or limescale formation or overheating phenomena or limescale formation over a small surface area are possible, as it were, by means of a dielectric layer between two electrically conductive connection areas.

### BRIEF SUMMARY

The invention is based on the problem of providing a heating device of the kind cited in the introductory part and also a method for operating the heating device, with which heating device and method problems encountered in the prior art can be solved and it is possible, in particular, to identify limescale formation on a medium side of the carrier and therefore a potential source of danger and to prevent damage to the heating device.

This problem is solved by a heating device and also by a method. Advantageous and preferred refinements of the invention are the subject matter of the further claims and will be explained in greater detail below. In the process, some of the features will be cited only for the heating device or only for the method. However, independently thereof, the intention is for it to be possible for the features to apply automatically and independently of one another both to the heating device and to the method. The wording of the claims is incorporated in the content of the description by express reference.

It is provided that the heating device for heating water, which water is intended to flow through a carrier or is intended to flow past the carrier in particular, has a carrier of this kind, primarily on a so-called medium side of the carrier. At least one heating element is applied to this carrier, the heating element having a single heating conductor or a plurality of heating conductors which are connected one behind the other. The heating element is advantageously a thick-film heating element comprising two electrical connections between which the single heating conductor or the individual heating conductors thereof which are connected one behind the other or adjoin one another extend. Therefore, the heating conductors can, for example, each be straight sections of the heating element which can have, in particular, a meandering profile overall. A plurality of heating elements which are designed in this way, advantageously at least two, can also be provided.

The heating device has at least one flat dielectric layer which substantially covers the heating conductors or the heating element. The dielectric layer does not necessarily have to lie directly on the heating element. It actually has electrically insulating properties, but its electrical resistance drops at temperatures starting from 200° C. or only starting from 300° C. Dielectric layers of this kind are composed, for example, of glass or glass-ceramic and are described in greater detail in abovementioned document DE 102013200277 A1.

Both sides of a dielectric layer are in each case provided with an electrically conductive connection area. These connection areas therefore bear directly against the dielectric layer and can detect, in particular, a current flowing through the dielectric layer or so-called leakage current. In this case, the electrically conductive connection areas can have the same coverage, this relating at least to an outer contour or maximum span of the surface area, depending on how many dielectric layers are provided next to one another on or above the heating elements. One of the electrically conductive connection areas can advantageously also be designed to cover the entire area or to be closed.

At least one of the connection areas is connected to a controller or measuring device of a controller for evaluating a leakage current as current flow through the dielectric layer. Therefore, even the leakage current can be monitored in respect of its time profile or a possible rapid increase. Furthermore, the heating element is connected to measuring means for monitoring a heating conductor current through this heating element and therefore through all of the heating conductors of the heating element. Therefore, even the heating conductor current can also be monitored or evaluated, in particular in respect of a drop on account of increasing resistance of the heating element as the temperature increases or owing to an excessively high temperature when the heating element has a positive temperature coefficient of its resistance in a refinement of the invention. When the heating element has a negative temperature coefficient of its resistance in another refinement of the invention, an increase in the heating conductor current on account of decreasing resistance of the heating element as the temperature increases or owing to an excessively high temperature can be identified. Since the controller or measuring device monitors the heating conductor current and, to this end, the voltage can also be measured, the heat transfer can also be assessed in the form of a thermal resistance.

It is therefore possible to monitor the temperature conditions at the heating element or at the heating device both by means of the leakage current at the dielectric layer and also by means of monitoring the heating conductor current. Although a change in the heating conductor current is rather relatively slow and also does not change very sharply overall when there is locally limited limescale formation or limescale formation over a small surface area since only a very small region of the heating element is affected thereby, it is, however, thus possible to determine, as it were, a temperature which is averaged over the surface area and therefore also averaged overheating at the heating device. Determining locally limited overheating or overheating over a small surface area by means of evaluating the leakage current at the dielectric layer is firstly considerably quicker and secondly a region which is only a few millimeters in size and has a very high temperature is sufficient here, so to speak, in order to allow the leakage current, which can be detected over the full surface area, to increase very sharply. Overheating phenomena of this kind generally occur due to limescale formation, as will be explained in greater detail below, or else due to a heating device which is filled with water boiling dry or drying out when used in a pump. There are also so-called hotspots which are produced by limescale formation not being completely removed at points or over a small surface area, wherein heat transfer is then additionally impeded by an intermediate space between the medium side of the carrier and the layer of limescale formation. Dangerous overheating phenomena can occur here, the overheating phenomena occurring over a small surface area or being locally very limited but it also being possible here for the overheating phenomena to damage or destroy the heating device.

The carrier is advantageously composed of metal. In order to produce a layer structure, an insulating layer is applied to the carrier, and the heating element or the heating elements is/are applied to the insulating layer in turn. As mentioned in the introductory part, thick-film heating elements are preferred, for example with precisely one or with a plurality of heating conductors in meandering form overall. Flat dielectric layers, advantageously as closed areas, are in turn applied over or to the heating element or the heating elements. It can substantially cover a rectangle. A dielectric layer also acts as an electrical insulation, at least in the region of conventional operating temperatures. An electrically conductive connection area can in turn be applied to the dielectric layer over substantially the same area. Any desired electrically conductive material can be used here. The other electrically conductive connection area on the dielectric layer is then formed by the heating element or the heating elements or the heating conductors of the heating element. During operation of the heating device, these are connected to an operating voltage and the heating conductor current flows through them. As the insulating properties of a dielectric layer become less effective, a conventionally lower current can then flow as leakage current through the dielectric layer to the other electrically conductive connection area. This can be identified by the abovementioned connection to a controller.

The controller advantageously has a memory in order to store reference values for the heating element temperature, dielectric layer signals or a heating conductor current during normal operation. Values can also be stored for abnormal operating states, in particular for locally limited limescale formation or limescale formation over a small surface area in respect of the dielectric layer signals which can then be expected or in respect of a heating conductor current and also values for abovementioned hotspots and for flat areas of limescale formation or limescale formation over a large surface area. This can be, for example, a limit value for the dielectric current or leakage current which must not be exceeded or at which the heating device has to be switched off.

A power density of the heating element can advantageously be at least 30 W/cm2 or at least 100 W/cm2. The power density can particularly advantageously be at most 150 W/cm2 or even 200 W/cm2. A rapidly responding very powerful heating device with a low space requirement is provided in this way.

In one refinement of the invention, the heating elements engage one in the other or are arranged in an interleaved manner, preferably with heating conductors as sections of the heating elements which run in a straight line and parallel in relation to one another. Therefore, the heating elements can advantageously run in a bifilar manner, in particular in a meandering form. At least one heating conductor of another heating element can run between two parallel heating conductors of a heating element, in particular parallel in relation to the heating conductors.

In an alternative refinement of the invention, the heating elements run close to one another, but have separate areas and do not even engage one in the other. Each heating element takes up, as it were, an area with a closed outer contour, in particular a rectangular area or a square area, into which no part of another heating element projects.

The heating device advantageously has precisely two or three heating elements. According to the first refinement of the invention mentioned above, two heating elements can engage one in the other or can be arranged in an interleaved manner. An additional third heating element can be provided, but that then has a separate area. If precisely three heating elements are provided, all three of them can advantageously run close to one another and have separate areas according to the second refinement of the invention mentioned above.

According to a first embodiment of the invention, a single flat dielectric layer can be provided on one side of the heating elements for the purpose of connection to the controller or measuring device for detecting a leakage current, wherein the dielectric layer substantially covers all of the heating elements. One connection area is then formed by the heating elements in each case. The difference between the heating elements in terms of area is achieved in this way. The other connection area, for example as an electrode, can cover the dielectric layer either over the full surface area or else be divided into a plurality of connection areas or component electrodes, the divided portions of which correspond, in turn, to the heating elements or precisely cover the heating elements substantially with their profile. This has the advantage that complicated profiles for the heating elements, in particular profiles which engage one in the other, can also be precisely replicated by the connection areas.

According to a second embodiment of the invention, a dedicated flat dielectric layer with a respectively dedicated electrically conductive connection area on the flat dielectric layer can be provided for each of the heating elements, wherein each dielectric layer substantially covers the associated heating element and does not cover any of the other heating elements. In the process, the dielectric layers can preferably run on one side of the heating elements in the same plane and electrically separated from one another, wherein all of the dielectric layers are connected to the controller or measuring device for detecting a leakage current. When there are a plurality of dielectric layers, they can all be identical or have identical properties and values in respect of insulating properties, temperature dependency or the like, for example also the same thickness.

In the method according to the invention, during operation of the heating device for heating water, both the heating conductor current through the heating element or through the heating conductors and also a leakage current through the dielectric layer are monitored, the time profiles of the currents being monitored for this purpose and, under certain circumstances, also being stored as an operation log. It is necessary to distinguish between three cases here.

In a first case of a heating conductor with a positive temperature coefficient, that is to say a PTC heating conductor, limescale formation over a large surface area of a medium side of the carrier can be identified if there is a slow or, as it were, excessively slow drop in the heating conductor current, or a slow drop of this kind in the heating conductor current can be defined as limescale formation over a large surface area of this kind. Limescale formation over a large surface area grows slowly over the operating time, the heating conductor temperature increases slowly with the operating time owing to the decreasing heat-absorbing capacity, and the heating conductor current drops. Various measures can follow, for example indicating to a user that limescale removal or cleaning of the heating device is necessary, or a temporary reduction in power together with indication at the same time. A slow drop of this kind in the heating conductor current can occur when the heating conductor current drops by at least 2% in less than 100 hours. Under certain circumstances, the heating conductor current can also drop by at least 3% to 5% in a less than 100 hours, in order to be identified as limescale formation over a large surface area of this kind. The drop in the heating conductor current is assessed at approximately the same water temperature since the heating conductor current likewise falls when the water is heated owing to the increasing heating conductor temperature which results. This will also be explained in concrete terms later with reference to FIG. 5.

A temperature sensor can be provided on the heating device, advantageously at a distance from the heating element or the heating conductors of the heating element. The temperature sensor can be a small sensor, for example an NTC. The distance should be of such a size that the temperature sensor detects only the temperature at the carrier and therefore that of the water.

In a second case of a heating conductor with a negative temperature coefficient, that is to say an NTC heating conductor, limescale formation over a large surface area of a medium side of the carrier can be identified if there is a slow or, as it were, an excessively slow increase in the heating conductor current, or a slow increase of this kind in the heating conductor current can be defined as limescale formation over a large surface area of this kind. However, otherwise, the same values as explained before for the first case can apply, specifically that a slow increase of this kind in the heating conductor current can occur when the heating conductor current increases by at least 2% in less than 100 hours. Under certain circumstances, the heating conductor current can also increase by at least 3% to 5% in a less than 100 hours.

In a third case, an excessively rapid increase in the leakage current can be identified as locally limited limescale formation on or limescale formation over a small surface area of or an abovementioned hotspot on the medium side of the carrier. This should be apparent to the controller but does not yet necessarily lead to the heating power being reduced or the heating device being switched off. An excessively rapid increase of this kind in the leakage current can occur when the leakage current increases by at least 30% in less than 20 hours, under certain circumstances even by at least 30% in less than 5 hours or by at least 50% in less than 10 hours. As a further condition, it may be provided that an absolute maximum value or limit value for the leakage current is exceeded, not only so that locally limited limescale formation or limescale formation over a small surface area of this kind or a hotspot on the medium side of the carrier is identified, but rather so that the heating power is at least reduced or the heating device is even switched off. This absolute limit value can be, in particular, at least 200% of the leakage current which occurs at the beginning of operation of the heating device in the relatively clean state or without limescale formation on the medium side of the carrier. An absolute limit value for the leakage current can also be provided. For example, it can be provided that the leakage current has to be at most 20 mA or 30 mA, otherwise the heating device is switched off due to a hotspot.

Here, a plurality of heating elements can be operated individually one after the other, wherein, in each individual operating situation, the leakage current at the at least one dielectric layer over the respectively just operated heating element is detected and, under certain circumstances, also stored as an operation log. It is necessary to distinguish between two options here. In the case of a first option of the leakage current in each case being the same, in particular differing by at most 10% to 20%, during individual operation of the heating elements, limescale formation over a large surface area of the medium side of the carrier is identified or this is assessed as limescale formation over a large surface area. In the case of a second option of the leakage current being different or differing by at least 10%, in particular differing by at least 30%, during individual operation of the heating elements, locally limited limescale formation on or limescale formation over a small surface area of the medium side of the carrier in the region of the heating element with the higher leakage current is identified or an abovementioned hotspot is identified.

In a further refinement of the invention, it can be provided that an optical and/or acoustic signal is sent to an operator in the case of limescale formation over a large surface area of the medium side of the carrier having been identified. In this way, the operator is intended to be informed that the heating device or the appliance which is provided with the heating device should be cleaned or limescale should be removed from the heating device or the appliance. In this case, operation of the heating device can still continue without problems either at full heating power or else at least at reduced heating power. It can also be provided that, when a first limit value for limescale formation over a large surface area is reached, the heating power has to be reduced by 20% to 50%, but the heating device can at least still be further operated. When a second limit value is reached, either operation can then be continued only at a low heating power, for example at most 20% to 30%, or else the heating device is completely switched off. A reduction in the power of the heating device can be uniformly distributed between the individual heating elements here when a plurality of individual heating elements are provided.

In the case of locally limited limescale formation or formation of limescale over a small surface area or a hotspot having been identified owing to an excessively rapid sharp increase in the leakage current as explained above, the heating power of the heating element in question can be sharply reduced. In particular, this heating element or, as an alternative, the entire heating device, can also be immediately switched off. This applies particularly when, as explained above, an absolute maximum value or limit value for the leakage current has also been exceeded. Otherwise, there is specifically the risk of permanent damage to or even destruction of the heating device not only in the region of this heating element but even of the entire heating device. It is then possible, after a waiting period of 2 seconds to 20 seconds, to switch on the heating device or the heating element in question again, advantageously at the same heating power as before or immediately at full heating power, that is to say very rapidly. Owing to a rapid change in temperature, locally limited limescale or limescale over a small surface area, possibly even at the hotspot, can be chipped away. This process can also be repeated several times, for example twice to five times or even ten times, under certain circumstances. Only when, during monitoring of the leakage current and the renewed very rapid sharp increase in the leakage current and also possibly a difference between the individual heating elements, it is identified that there is still locally limited limescale or limescale over a small surface area or of the hotspot on the heating device or the heating element in question, which limescale then has obviously not been chipped away or cannot be removed, the heating power at this heating element should be reduced as prescribed and this heating element or, under certain circumstances, even the entire heating device should be switched off while providing an operator with a corresponding fault indication. Chipping away or removal of locally limited limescale or limescale over a small surface area or a hotspot of this kind can be identified specifically by the leakage current not immediately rapidly sharply increasing again after the heating device is switched on again, in particular at the previously set or full heating power.

When there are a plurality of heating elements, in a situation after identification of locally limited limescale formation on or limescale formation over a small surface area of the medium side of the carrier in the region of a heating element, the power of this heating element can be reduced or the heating element can be completely switched off. At least one further heating element is then further operated at an unchanged power since the further heating element does not present a danger. In the case of limescale formation over a large surface area of the medium side of the carrier being identified, the heating element located there or a heating element in general can be connected in series with at least one further heating element in order to further operate the heating device at a power which is reduced overall. This can involve two types of emergency operation.

In order to set different powers at the heating device, the individual heating elements can be connected up differently, preferably operated in series or in parallel or individually. The heating elements advantageously have different power values. They can then be connected in series, individually or, for maximum power, in parallel in accordance with the power grading.

In a further refinement of the invention, it can be provided that, if neither monitoring of the heating conductor current indicates a slow drop or increase nor monitoring of the leakage current through the dielectric layer indicates a rapid sharp increase within seconds or within 1 minute, but both a sharp increase in the leakage current and a relatively rapid drop or corresponding increase in the heating conductor current occur at the same time at a specific point in time, this is assessed as a container which is provided with the heating device having boiled dry or drying out when the heating device is used in a pump. Boiling dry in this way or the resulting overheating usually affects the entire heating device or the entire carrier. For this reason, different behavior of several heating elements cannot be determined here together with the abovementioned rapid and approximately identical increase in the leakage current. In this case, the heating conductor current drops considerably more rapidly, specifically on account of the relatively rapid increase in temperature of the entire heating device, in the case of a PTC heating conductor or the heating conductor current rises considerably more rapidly in the case of an NTC heating conductor than when there is limescale formation over a large surface area. No more heat is absorbed. Furthermore, the leakage current also increases, however at virtually the same rate as the heating conductor current drops or increases since there is no local overheating but rather overheating over a large surface area or over the full surface area. In this case, the entire heating device should be immediately switched off since further operation would make no sense in any case and primarily the risk of damage is too high. In addition, a corresponding signal should be output to an operator.

In a further preferred refinement of the invention, the method is used for operating a heating device according to the invention of a dishwasher, wherein the dishwasher advantageously has a controller for operating a water softening arrangement in the dishwasher. It can be provided that, at the beginning of operation of the dishwasher, that is to say after the dishwasher is first started up, water softening in the dishwasher is lowered for a lower level of water softening. This can be lowered or operated in the lowered state until limescale formation over a large surface area of a medium side of the carrier is identified, preferably by means of a corresponding slow drop or increase in the heating conductor current in the manner explained above. In response to this, a signal can be sent to an operator to the effect that limescale has to be manually removed from the carrier or the heating device. The controller of the dishwasher can automatically increase the level of water softening again, in particular sharply increase the level of water softening for a short period of time and then lower it somewhat again, in order to then operate further at a reduced level of water softening. For use in a dishwasher, a heating device according to the invention of this kind can be incorporated, for example, in a pump for heating and for conveying the water in the dishwasher, as is described, for example, in US 2013/287561 A1.

These and further features are apparent not only from the claims but also from the description and the drawings, where the individual features can in each case be realized on their own or jointly in the form of subcombinations in an embodiment of the invention and in other fields and can constitute advantageous and inherently protectable embodiments for which protection is claimed here. The subdivision of the application into individual sections and sub-headings does not restrict the general validity of the statements made thereunder.

### BRIEF DESCRIPTION OF THE SEVERAL VIEWS OF THE DRAWINGS

Exemplary embodiments of the invention are schematically illustrated in the drawings and will be explained in greater detail in the text which follows. In the drawings:

FIG. 1 shows an exploded illustration of a first embodiment of a heating device according to the invention comprising a single heating element in a layer structure;

FIG. 2 shows a lateral illustration of a second embodiment of a heating device according to the invention comprising two heating elements;

FIG. 3 shows a plan view of the heating device from FIG. 2;

FIGS. 4 to 6 show various graphs with profiles of the leakage current and of the heating conductor current; and

FIG. 7 shows a graph of a profile of the heating conductor current and of the power with slow limescale formation over a large surface area.

### DETAILED DESCRIPTION

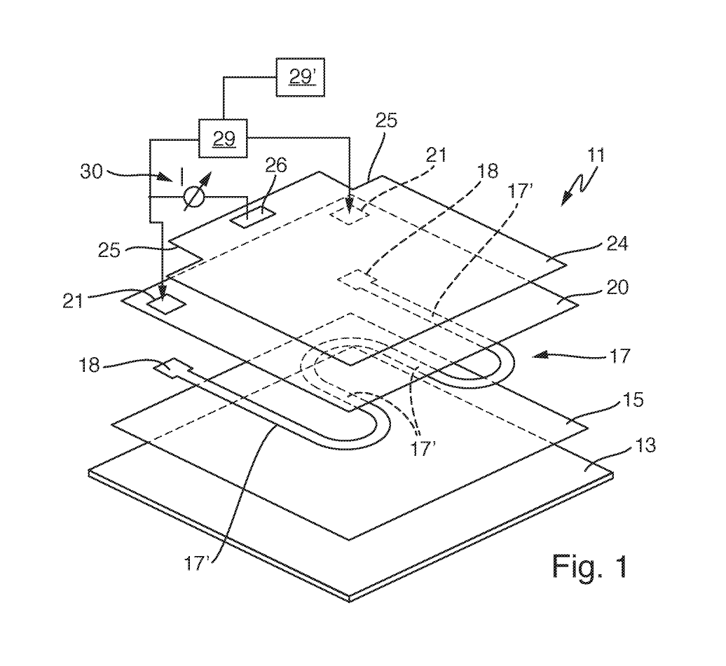

FIG. 1 shows an oblique view of an exploded illustration of a first embodiment of a heating device 11 according to the invention, the view showing the layer structure of the heating device. The heating device corresponds to that of abovementioned document DE 102013200277 A1. The heating device 11 has a carrier 13 which is composed of metal or stainless steel here. The carrier can be flat or planar, or as an alternative can also be tubular, as is known from abovementioned document US 2013/287561 A1. Water which is to be heated is located on or flows past the bottom side or medium side of the carrier. A dielectric insulating layer 15 is provided on the carrier 13 as base insulation of the carrier 13 and can be composed of glass or glass-ceramic. The glass or glass-ceramic has to provide electrical insulation, even at high temperatures. A material of this kind is known in principle to a person skilled in the art for insulating layers.

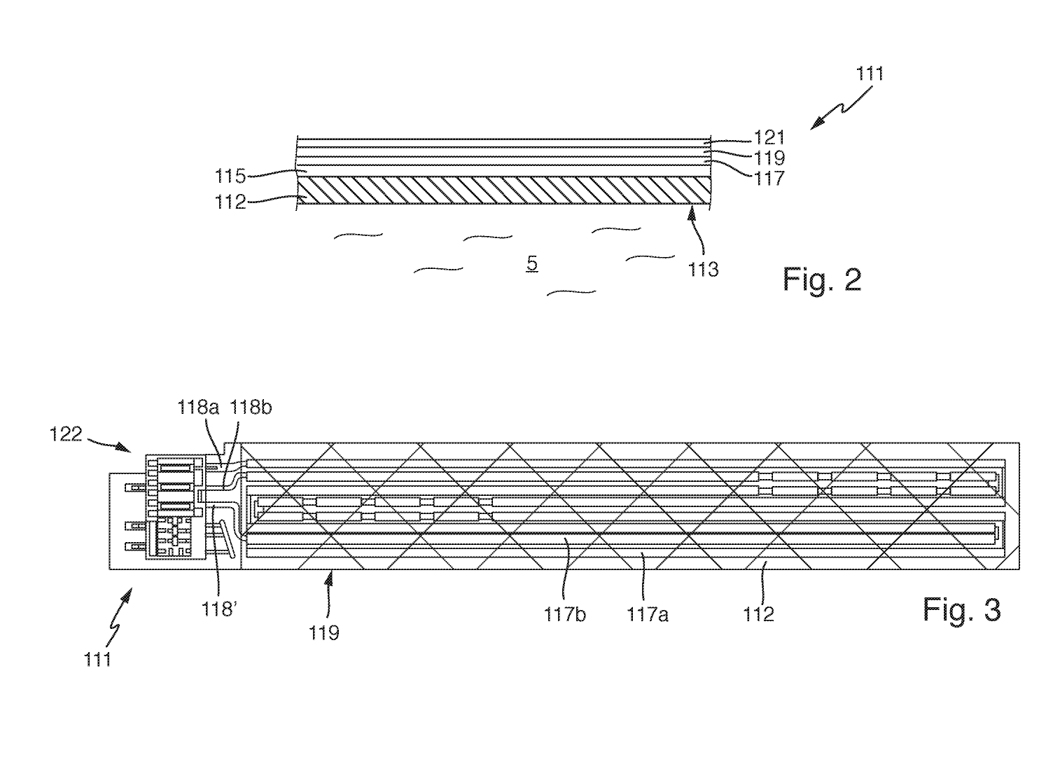

A single heating element 17 with a meandering profile is applied to the first insulating layer 15, the single heating element being composed of individual heating conductors 17 which are connected one behind the other or in series. The heating conductors are largely straight and are connected by bent sections. However, a single heating conductor which is also considerably wider than the narrow heating conductors 17 illustrated here could also be provided, also see FIG. 2 in this respect. The heating element 17 is designed as a thick-film heating element which is composed of conventional material and is applied using conventional methods. Enlarged fields are located at the two ends of the heating element as heating conductor contacts 18 which are possibly also composed of different material, for example a contact material which is customary for thick-layer heating conductors and has a considerably better electrical conductivity and primarily better contact-making properties.

A dielectric layer 20, which can be glass-like or can be a glass layer, is applied over a large surface area of the heating element 17. The dielectric layer 20 closes, as it were, the heating device 11 or insulates the heating element 17 and closes the heating element and also the layer structure, in particular against harmful or aggressive environmental influences. For the purpose of making electrical contact with the heating element 17 or the heating conductor contacts 18 of the heating element, the dielectric layer 20 has windows 21 precisely above the heating conductor contacts 18 for the purpose of plated-through connection in a manner which is known per se.

An electrode 24 is applied to the dielectric layer 20 as an electrically conductive connection area, specifically in the form of a layer of large surface area. The electrode is precisely the same size as the carrier 13 and the insulating layer 15 here. The electrode 24 is not intended to directly overlap the carrier 13 or the heating element 17 since it has to be insulated from the carrier 13 and the heating element 17. A further cover or insulating layer can be located on the electrode 24, but does not have to be. The cover or insulating layer has two cutouts 25 at the corners, the cutouts, together with the windows 21 in the dielectric layer 20 situated beneath them, allowing the above-described contact-connection to the heating conductor contacts 18. The heating element 17 or the heating conductors 17′ of the heating element form the other or first connection area.

The figure also shows a controller 29 with a power supply for the heating element 17. The controller has a memory 29′. This is known from the prior art and does not need to be explained in further detail. The figure also shows a measuring device 30 which is connected at one end to the electrode 24 by means of an electrode contact 26 and is connected at the other end to the heating element 17. As has been explained above, the dielectric or resistive properties of the second dielectric layer 20 change as the temperature changes, and the current or discharge current which is detected by the measuring device 30 changes accordingly or increases as the temperature increases. The measuring device then detects this change in the properties of the dielectric layer 20 between the heating element 17 and the electrode 24.

FIG. 2 shows a highly simplified lateral illustration of a second embodiment of a heating device 111 according to the invention in a layer structure. A carrier 112, which can form a container, such as a tube for example, has a medium side 113 at the bottom as a bottom side along which water 5 flows or at which water 5 is present. This water 5 is intended to be heated by the heating device 111. A base insulation 5 is provided on the top side of the carrier 112 as an insulating layer. A heating element 117 is in turn applied to the insulating layer, here as a flat heating element or using thick-film technology. A dielectric layer 119 is applied to the heating element 117, specifically in a different flat design, as has been explained above and will be shown with reference to FIG. 3. An electrode area 121 is in turn applied to the dielectric layer 119 as top connection area to the dielectric layer 119 which is composed of electrically conductive material. The flat design of the electrode area can also be variable. Here, the heating element 117 also serves as a lower connection area to the dielectric layer 119, as has been explained above.

There is a danger of limescale formation on the medium side 113 of the heating device 111, this being accompanied by the risks of an excessive increase in the temperature and damage to or even destruction of individual heating elements 117 or the heating device 111. For this reason, care should be taken that this does not happen, specifically at the high power densities cited here.

In line with FIG. 1 or DE 102013200277 A1, a controller, a memory and a measuring device are connected to the heating device 111, this not being illustrated here but being easy to imagine.

FIG. 3 shows a plan view of the heating device 111 which can either be flat or can be a tube, so that FIG. 3 shows the unwound carrier in this case. Two heating elements, specifically a first heating element 117a and a second heating element 117b, are applied to the carrier 112. The heating element 117a forms one component heating circuit and the heating element 117b forms one component heating circuit. The two heating elements 117a and 117b are interleaved or run one into the other in a meandering manner, so that they ultimately heat the same area of the carrier 112 when they are individually operated and when they are operated together in any case. Therefore, different distribution of the heating power of the heating device 111 within the heating device is possible as it were. At the maximum desired heating power, the two heating elements 117a and 117b are operated in parallel. At the minimum desired heating power, the two heating elements 117a and 117b are operated in a manner connected in series, possibly even in the manner of emergency operation as explained above. At a desired heating power between the maximum and minimum desired heating powers, one of the heating elements 117a and 117b is operated. If the heating elements have different power values, the appropriate power can be generated by respectively individual operation.

The two heating elements 117a and 117b have the same length and each have four longitudinal sections. The two heating elements 117a and 117b also have interruptions due to contact bridges on two longitudinal sections, which are situated next to one another, in a known manner. Therefore, the heating power can be locally lowered to a certain extent. Electrical contact-connection between the heating elements 117a and 117b is made by means of the individual contact areas 118a and 118b and also a common contact area 118′. The figure also schematically shows a plug-type connection 122 which is fitted to the contact areas 118 or to the carrier 112, advantageously according to EP 1152639 B1.

It is easy to imagine how a third heating element could also run, for example, separately next to the two heating elements 117a and 117b, or else could engage into the central intermediate space between the inner heating conductors of the heating element 117a. Under certain circumstances, the third heating element could also run along the two outer heating conductors of the heating element 117a and would therefore also be virtually interleaved.

A single flat dielectric layer 119 which is composed of a suitable material is applied to the heating elements 117a and 117b, illustrated here by the crosshatching. The dielectric layer completely covers the two heating elements 117a and 117b and extends as far as the edge of the carrier 112 or just in front of the edge.

An electrode area 121, specifically as an electrode of full surface area here, is in turn applied to the dielectric layer 119. Therefore, although separate temperature detection or detection of limescale formation is not possible with differentiation in various areas, a simple design is ensured. Differentiation over the surface area takes place by the prescribed separate individual operation of the heating elements 117a and 117b. Electrical contact is made with the electrode area 121, in a manner which is not illustrated, advantageously by means of the plug-type connection 122.

On the basis of FIG. 3, it is easy to imagine how differentiation over the surface area is possible by, in a first refinement, a dielectric layer 119 of large surface area further being applied to the two or all of the heating elements 117. However, the electrode area is divided into two component electrode areas in this case. In the process, each component electrode area runs in a manner corresponding to the heating element which is situated below it, under certain circumstances even with precise coverage. Therefore, the component electrode areas are also separated from one another. In this case, temperature monitoring can take place precisely at each component electrode area and only for the heating element which is situated below the component electrode area. Therefore, the problem of there being only one single dielectric layer 119 of full surface area does not arise here.

In a second refinement, the dielectric layer could also be divided into two or correspondingly a large number of component dielectric layers with a profile corresponding to the heating element which is situated below the component dielectric layers. In this case, a component electrode area of corresponding design is also applied for each component dielectric layer. However, in this case, the outlay on manufacturing would obviously be considerably higher.

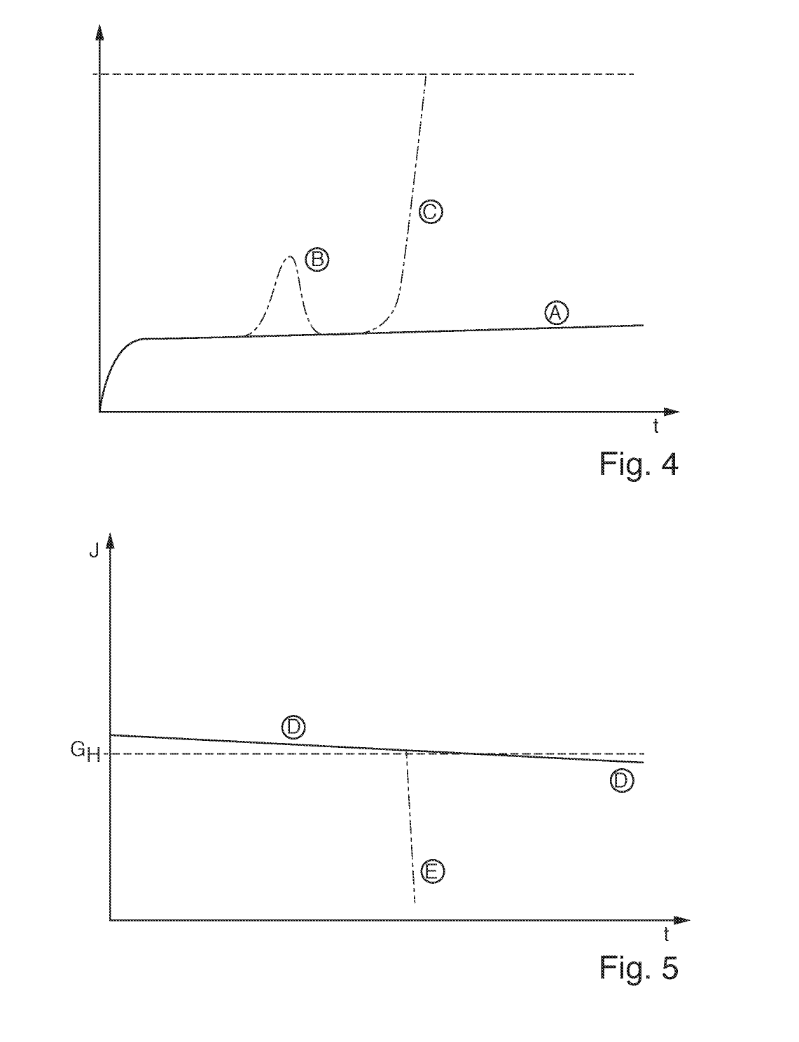

FIG. 4 schematically shows how the signal or a leakage current changes over time in accordance with the y-axis. Here, the time profile is illustrated over several hours, for example over 160 hours as the operating period. The profile A, which is illustrated by a solid line, indicates normal operation, with the slight increase in the profile A being due to slow limescale formation over the surface area of the heating device 11 or 111 or over the medium side of carrier 13 or 113.

The profile B, which is illustrated by a dashed line, represents the occurrence of locally limited limescale formation or limescale formation over a small surface area or an abovementioned hotspot. The increase in the profile over a few hours, for example 1 hour to 5 hours up to the maximum, has more than twice the effect on the signal or leakage current at the maximum. In this case, in profile B, the limescale over a small surface area is chipped away or has been removed, for which reason the leakage current or the signal again drops in this profile B and then corresponds to the normal profile A again. The question as to whether the limescale has been completely or incompletely removed here cannot be answered on the basis of the drop alone. If profile B then continues to run parallel to profile A but at an increased value, it can be assumed that removal was not complete. Although this can be identified, countermeasures are not absolutely necessary.

The profile C, which is illustrated by a dashed-and-dotted line, indicates, similarly to profile B, the renewed formation of locally limited limescale or limescale formation over a small surface area. For this reason, the profile is intended to run similarly to profile B in the region in which it increases. However, the limescale is not removed here, there is still a hotspot, and for this reason the leakage current or the signal increases further. When a limit value for the leakage current is reached, here the limit value GL, which limit value is, for example, somewhat higher than a multiple of the normal leakage current in accordance with profile A, this is identified as dangerous locally limited limescale formation or limescale formation over a small surface area with an excessively high temperature. In this case, the heating power at the single heating element 17 or at one of the heating elements 117a or 117b is correspondingly sharply reduced or the heating element is even switched off, in order to avoid damage. The controller 29 can send a signal, not illustrated, to call up an operator for servicing purposes or for limescale removal purposes.

FIG. 5 shows profiles D and E for the heating conductor current I over time t, specifically again over a time axis of several hours. The profile D, which is illustrated by a solid line, corresponds to normal operation, with the slight drop in the heating conductor current representing slow limescale formation over a large surface area or over the full surface area of the medium side of the carrier 13 or 113. Furthermore, a limit value Gil for the heating conductor current is illustrated by a dashed line and can amount to, for example, 90% or 80% of the heating conductor current at the beginning, it being 90% here. If this limit value G_{H} is undershot, the limescale formation over a large surface area of the medium side of the carrier 13 or 113 is excessively severe, and accordingly heat absorption by the water is excessively low and the danger of overheating of the heating device is excessively high. Therefore, this can also be evaluated as a signal, so that the controller 29 reduces the heating power or switches off the heating device 11 or 111 along with sending a corresponding signal to an operator. In the illustrated example, this can take place after approximately 10 to 20 hours.

The profile E, which is illustrated by a dashed-and-dotted line, is intended to schematically show how the heating conductor current drops considerably more sharply or more rapidly starting from a specific point in time when there is no water for heating purposes and for absorbing the heat on the medium side of the carrier 13 or 113. This is the above-described case of boiling dry or drying out in a PTC heating conductor. In this case, the limit value G_{H} is rapidly undershot, it again being possible for this to be identified by the controller 29. However, since the drop in the heating conductor current then takes place considerably more rapidly than in the case of profile D, this special case of the reduced heating conductor current can also be determined. If the leakage current also increases at the same time, for example similarly to in the case of profile C in accordance with FIG. 4, the controller 29 cannot evaluate this as a case of suddenly occurring locally limited limescale formation or limescale formation over a small surface area, and likewise not as a case of limescale formation over a large surface area, but rather as boiling dry or drying out. This can then be indicated to an operator by a special signal being sent. Furthermore, the controller 29 then switches off the heating device 11 or 111 completely in all cases since, firstly, there is otherwise the danger of damage and secondly continued heating no longer makes any sense.

In the case of boiling dry or drying out in this way, the heating conductor current drops so sharply, for example within less than 1 minute, for example within 10 seconds to 30 seconds, that it falls below the limit value G_{H}. The signal according to FIG. 4 then also increases correspondingly rapidly.

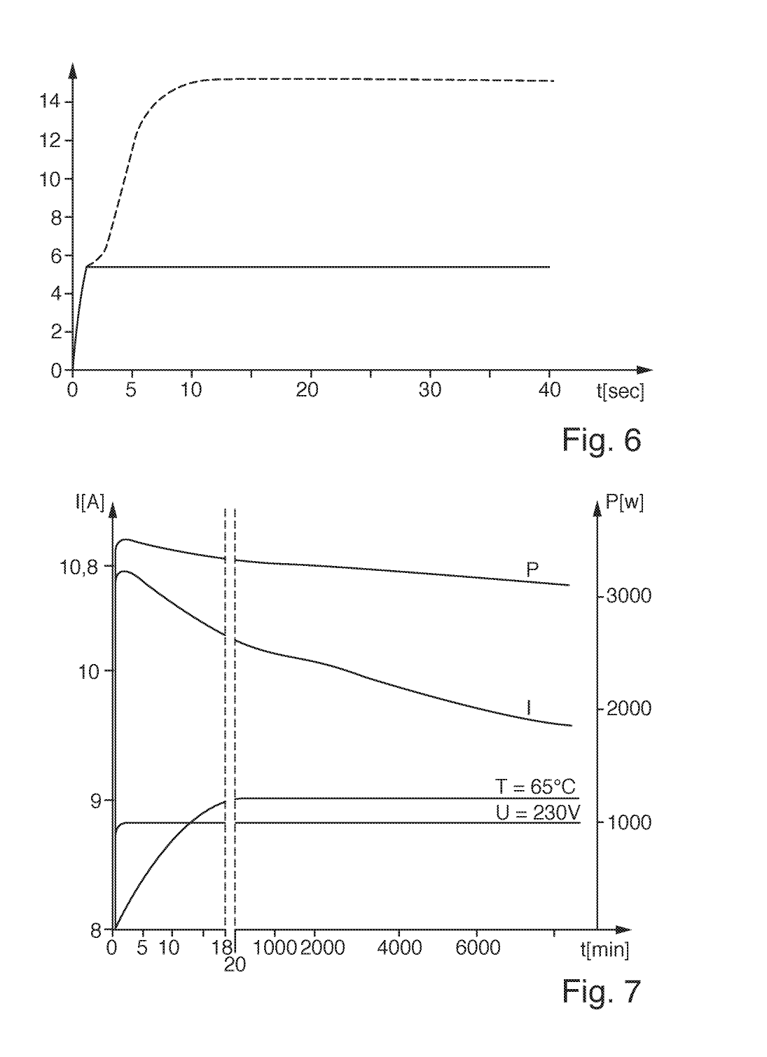

FIG. 6 illustrates how the leakage current, illustrated by a corresponding voltage of the measuring device 30 here, behaves in the seconds range at a water temperature of 50° C. when the heating device 11 or 111 or the single heating element 17 or the two heating elements 117a and 117b is/are switched on. The solid profile is normal operation, and therefore it is clear that, after one to two seconds, the leakage current reaches a value, which appears to be constant per se, with a profile corresponding substantially to the profile A of FIG. 4. If there is a hotspot or locally limited limescale formation or limescale formation over a small surface area as early as when the heating device 11 or 111 is switched on, the leakage current increases in accordance with the dashed profile to three times the value. However, if this limescale formation or this hotspot does not become larger or worse, a relatively stable state is likewise reached, this being illustrated by the substantially constant profile. In this case, the leakage current requires approximately 10 seconds to increase, that is to say it is also a very rapid process.

FIG. 7 illustrates how the heating conductor current I behaves over time t (in minutes) when limescale formation over a large surface area grows. The heating conductor current I is plotted on the left-hand-side y-axis and the power P is plotted on the right-hand-side y-axis. The voltage U and the temperature T are also plotted, neither provided with a scale but with the correct relative profile. The basic profiles of the heating conductor current I and power P over 100 operating hours illustrate, by way of example, the growth of limescale over a large surface area under the operating conditions of U=230 V and a temperature of T=65° C. This can also be added up over a large number of operating cycles. The scale of the time axis in the region on the left of the twin dashed lines is not the same as the scale of the time axis in the region on the right of the twin dashed lines, but is linear within each of the two regions.

After switch on at t=0, the heating conductor current I increases to a maximum value as the voltage increases, as does the power P, for example within a few seconds, and then they both drop. The temperature T increases more slowly until it has reached 65° C. This occurs after approximately 18 minutes in this case. Since heating of the heating element then ceases on account of the water being heated now at a constant water temperature and therefore the resulting share of the change in the resistance of the heating element and therefore in the heating conductor current I, the drop in the heating conductor current becomes weaker or smaller. Limescale formation over a large surface area begins here. Therefore, the limescale formation starts as early as at a temperature which, at 65° C., is considerably below that of boiling water. Owing to this resulting limescale formation over a large surface area, the heating conductor current I drops further, for example approximately 6% in 100 hours or 6000 minutes. The heating power drops in a corresponding manner since the voltage U obviously remains the same.

That which is claimed:

1. A heating device for heating water flowing through or flowing past a carrier of said heating device, wherein at least one heating element is applied to said carrier, the heating device comprising:
one heating conductor or a plurality of heating conductors which are connected one behind the other;
at least one flat dielectric layer which substantially covers said at least one heating element;
an electrically conductive connection area is in each case provided on both sides of said dielectric layer;
at least one of said connection areas is connected to a controller or measuring device for detecting a leakage current as current flows through said dielectric layer; and
said at least one heating element is connected to measuring means for monitoring a heating conductor current through said heating element.

2. The heating device according to claim 1, wherein:
said electrically conductive connection area is in each case provided on both sides of said dielectric layer having the same coverage.

3. The heating device according to claim 1, wherein:
an insulating layer is applied to said carrier;
a heating element being applied to said insulating layer;
said flat dielectric layer is applied over said heating element;
an electrically conductive connection area is applied to said dielectric layer, with substantially a same area; and
said other electrically conductive connection area is formed by said heating element.

4. The heating device according to claim 1, wherein:
said flat dielectric layer covers a closed area as substantially a rectangle.

5. The heating device according to claim 1, wherein:
a power density of said heating element is at least 30 W/cm2.

6. The heating device according to claim 1, wherein:
at least two heating elements which are electrically separated and/or can be operated independently of one another are applied to said carrier;
said heating elements engage one in the other or are arranged in an interleaved manner with heating conductors; and
at least one said heating conductor of another heating element runs between two parallel heating conductors of a heating element.

7. The heating device according to claim 6, wherein:
said heating elements engage one in the other or are arranged in an interleaved manner with heating conductors as sections of said heating elements which run in a straight line and parallel in relation to one another.

8. The heating device according to claim 6, wherein:
said at least one heating conductor of another heating element runs between two parallel heating conductors of a heating element, and said heating conductors are parallel in relation to each other.

9. The heating device according to claim 1, wherein:
at least two said heating elements which are electrically separated or can be operated independently of one another are applied to said carrier;
a single flat dielectric layer is provided on one side of said heating elements for the purpose of connection to said controller or measuring device for detecting a leakage current; and
said dielectric layer substantially covers said heating elements.

10. The heating device according to claim 1, wherein:
at least two said heating elements which are electrically separated or can be operated independently of one another are applied to said carrier;
a dedicated flat dielectric layer with a respectively dedicated electrically conductive connection area on said flat dielectric layer is provided for each of said heating elements; and
each dielectric layer substantially covers said associated heating element and does not cover any of said other heating elements.

11. The heating device according to claim 10, wherein:
said dielectric layers run on one side of said heating elements in the same plane and electrically separated from one another, and all of said dielectric layers are connected to said controller or measuring device for detecting a leakage current.

12. A method for operating a heating device according to claim 1 for heating water, wherein, during operation of the heating device, both a heating conductor current through said heating element or said heating conductors and also a leakage current through said dielectric layer are monitored over time, wherein the method comprises:
in the case of a PTC heating conductor, limescale formation over a large surface area of a medium side of said carrier is identified in an instance in which there is an excessively slow drop in said heating conductor current;
in the case of an NTC heating conductor, limescale formation over a large surface area of a medium side of said carrier is identified in an instance in which there is an excessively slow increase in said heating conductor current; and
locally limited limescale formation on or limescale formation over a small surface area of or a hotspot on a medium side of said carrier is identified when there is an excessively rapid increase in said leakage current.

13. The method according to claim 12, wherein:
in said case of a PTC heating conductor, limescale formation over a large surface area of a medium side of said carrier is identified in an instance in which there is an excessively slow drop in said heating conductor current of at least 2% in 100 hours.

14. The method according to claim 12, wherein:
in said case of an NTC heating conductor, limescale formation over a large surface area of a medium side of said carrier is identified in an instance in which there is an excessively slow increase in said heating conductor current of at least 2% in 100 hours.

15. The method according to claim 12, wherein:
locally limited limescale formation on or limescale formation over a small surface area of or a hotspot on a medium side of said carrier is identified when there is an excessively rapid increase in the leakage current by at least 30% in less than 20 hours.

16. The method according to claim 12, wherein:
said absolute maximum value is 200% of said leakage current at a beginning of operation of said heating device without any limescale formation on a medium side of said carrier.

17. The method according to claim 12, wherein:
said absolute maximum value is 300% of said leakage current at a beginning of operation of said heating device without any limescale formation on a medium side of said carrier.

18. The method according to claim 12, wherein:
after limescale formation over a large surface area of a medium side of said carrier is identified, a signal is sent to an operator that cleaning or limescale removal should be performed.

19. The method according to claim 12, wherein:
in said case of locally limited limescale formation on a small surface area of said medium side of said carrier or limescale formation over a small surface area of said medium side of said carrier being identified, said heating power of said heating element in a region of which said locally limited limescale formation or limescale formation over a small surface area occurs is reduced.

20. The method according to claim 19, wherein:
said heating element or said heating device is immediately switched off and, after a waiting period of 2 seconds to 20 seconds, said heating element or said heating device is switched on again.

21. The method according to claim 20, wherein:
switching off and switching on of said heating element or of said heating device are repeated several times in order to chip away said locally limited limescale or limescale over a small surface area due to a rapid change in temperature.

22. The method according to claim 12, wherein:
if neither monitoring of said heating conductor current indicates a slow drop or increase nor monitoring of said leakage current through said dielectric layer indicates a rapid sharp increase, but both a rapid drop or increase in said heating conductor current and a rapid sharp increase in said leakage current occur at a same time at a specific point in time, this is assessed as a case where a container being provided with said heating device having boiled dry.

23. The method according to claim 12, wherein at least two said heating elements which are electrically separated and/or can be operated independently of one another are applied to said carrier and, when a limit value for said leakage current is exceeded and/or when there is an excessively sharp increase in said leakage current, a fault search is started and, to said end, said heating elements are operated individually one after the other, and said leakage current at said at least one dielectric layer above said operated heating element is detected in each case, wherein the method comprises:
in the case of the leakage current in each case being the same, during individual operation of said heating elements, limescale formation over a large surface area of said medium side of said carrier is identified; and
in the case of said leakage current differing by at least 10%, during individual operation of said heating elements, locally limited limescale formation on or limescale formation over a small surface area of said medium side of said carrier in a region of said heating element with said higher leakage current is identified.

24. The method according to claim 23, wherein:
in the case of said leakage current in each case being the same and in each case indicating a rapid sharp and approximately identical increase during individual operation of said heating elements, this is identified as a case of a container being provided with said heating device having boiled dry.

25. The method according to claim 24, wherein:
in said case of a rapid sharp and approximately identical increase during individual operation of said heating elements by at least 20% in less than 1 minute, this is identified as a case of a container being provided with said heating device having boiled dry.

26. The method according to claim 23, wherein:
in said case of locally limited limescale formation on or limescale formation over a small surface area of said medium side of the carrier in said region of a heating element being identified, a power of said heating element is reduced or switched off and at least one further heating element is further operated at an unchanged power, wherein, in a further case of limescale formation over a large surface area of said medium side of said carrier being identified, said heating element is connected in series with at least one further said heating element in order to be further operated at a reduced power.

27. The method according to claim 12 in a dishwasher, wherein:
a controller of said dishwasher lowers a setting for operation of a water-softening arrangement in said dishwasher for a lower level of water softening until limescale formation over a large surface area of a medium side of said carrier is identified; and
said controller automatically increases or intensifies said level of water softening again in response to said limescale formation being identified.

28. The method according to claim 27, wherein:
said limescale formation over a large surface area of a medium side of the carrier is identified by means of a slow drop or a slow increase in said heating conductor current.
